(19) United States
(12) Patent Application Publication
(10) Pub. No.: US 2024/0066530 A1
(43) Pub. Date: Feb. 29, 2024

(54) METHOD AND DEVICE FOR SEPARATION AND SELECTION OF MOLECULES IN A GAS MIXTURE

(71) Applicant: Christos Ventures LLC, Cheyenne, WY (US)

(72) Inventor: Mats Hedman, Sparreholm (SE)

(21) Appl. No.: 18/037,898

(22) PCT Filed: Nov. 8, 2021
(86) PCT No.: PCT/SE2021/000010

§ 371 Date: May 19, 2023

(30) Foreign Application Priority Data
Nov. 19, 2020 (SE) 2000217-6
Nov. 19, 2020 (SE) 2000218-4

(51) Int. Cl. B04B 5/08; B01D 53/24; B04B 11/04; B04B 13/00; B04B 15/02

(52) U.S. Cl. CPC B04B 5/08; B01D 53/24; B04B 11/04; B04B 13/00; B04B 15/02; B01D 2257/104; B01D 2257/108; B01D 2257/504; B01D 2258/06; B01D 2259/4566

(57) ABSTRACT

The method for separation and selection of heavy and/or light molecules in a gas mixture through a device consisting of a cylinder, to the cylinder attached driving mechanism for bringing the cylinder into motion, a inside the cylinder firmly attached impeller, an inside the cylinder's center existing opening for passage of combustion gas, air, synth gas or another gas mixture, a to the opening connected armature involving an openable and closable outlet for carbon dioxide or oxygen or hydrogen or another selected separated gas that leads to a recipient, for example a compressor with a tank.

Examples of mixed gases with application of forementioned invention are common air for separation of oxygen and combustion gases for separation of carbon dioxide and synth gas for separation of hydrogen.

The air around us consists to the largest part of nitrogen at 78% and oxygen at 21%. In the air there's also small amounts of other gases making up circa 1%. Oxygen is manufactured through distillation of water and is used within health care and for industrial chemical applications and more.

Combustion gases from all sorts of emission sources contain carbon dioxide that contribute to global warming. CCS (Carbon Capture and Storage) is a known method which entails a chemical process where carbon dioxide is absorbed into an amine solution whereafter heat is added to release pure CO2 before it is compressed in order to be able to be transported to the place where it is to be stored which is primarily done in bedrock formations.

Separation of gases for example the oxygen in the air or carbon dioxide from combustion gases or hydrogen from gasified biomass or synth gas, can be done with centrifugation which this invention makes possible. Known methods are energy consuming and developed for continuous separation which leads to big complex facilities having to be constructed which becomes unprofitable. A device according to this invention can be made so small of a size that it can even be put inside a car and be used to separate carbon dioxide from the exhaust gas and/or to reduce nitrogen to increase oxygen concentrations in the air for an engine or a fuel cell. Furthermore, energy can be recycled. With centrifugation temperature and pressure in a gas mixture increases through compression which leads to the molecules colliding and bouncing off each other which counteracts and delays separation of the molecules. Therefore, the gas mixture during centrifugation can be cooled to hasten separation.

The purpose of this invention is to through a new method and device to separate and select for example oxygen or nitrogen in air or carbon dioxide in exhaust gas or hydrogen in synth gas. The principle for this invention is general and makes the separation and selection of any molecules in any gas mixture possible.

This invention involves a new type of centrifugal compressor, that works in three steps:

Step 1 involves the compressor rotating under increasing RPM in which gas is sucked inside centrally and compressed through radially acting g-force under release of heat to a cooling medium.

Step 2 involves that under essentially constant RPM further heat is released from the compressed gas and the gas continues to be sucked in and compressed as long as heat is released.

Step 3 involves the compressor brought to rotate under lowering of RPM in which the gas expands as it absorbs heat and is evacuated centrally.

Step 1 and 2 are work intensive and performed by an electric machine. Step 3 is work giving if the electric machine is made to brake the rotation through generation of electricity and therefore being made to recycle some of the electric energy used under Step 1 and Step 2.

This given method is for separation and selection of given gas mixtures' molecules through aforementioned steps of centrifugation.

This invention is based on the fact that molecules in gas mixtures weigh different amounts. For example oxygen(O2 with a molar mass of 2*16 u), nitrogen 28 u(N2, molar mass 2*14 u) water vapor (18 u: H2O, molar mass 2 u+16 u), nitrogen oxide 30 u(NO, molar mass 14u+16u), carbon dioxide 44 u(CO2 molar mass 12 u+32 u), hydrogen 2 u(H2, molar mass 2*1 u).

In the common air oxygen holds a big volume and the molecule is heavy. For example, carbon dioxide is heavier than oxygen but in the common air its volume is so small that it for this purpose, separation of oxygen from air, can be ignored. Thus, centrifugation is well-suited as a method for separation of oxygen from the air.

In combustion gas carbon dioxide holds a big volume proportionally speaking compared to its concentration in the atmosphere, and its molecule is relatively heavy and is thus well-suited for centrifugation as a means of separating carbon dioxide.

In gases produced through pyrolysis of biomass, synth gas, there for example exists hydrogen which is a very light molecule and therefore is well-suited for separation.

The invention involves an impeller in a cylinder that is brought under rotation according to above mentioned steps. During rotation the actual gas mixture is sucked inside the cylinder through an opening in its center and the gas mixture is forced through centrifugal force towards the cylinder's periphery. With a given constant RPM the supply of gas stops when the centrifugal force's effect on the molecules in the gas is balanced against the pressure in the now compressed, centrifuging gas. With continued rotation there is a separation of the molecules due to their individual, different molar masses and there is a collection of the heaviest molecules next to the peripheral wall of the cylinder while the lighter molecules are collected centrally. With compression the gas temperature is increased and the cylinder wall becomes heated. If the cylinder in rotation is cooled off through for example surrounding air there is a further increase in supplied gas because the cooling lowers the gas pressure. This can principally continue until the temperature in the cylinder wall is the same as the cooling medium. The compression that takes place during cooling is positive for the operating economy. If acceleration of the cylinder is adjusted accordingly as the heat energy in the gas that is compressed by the cylinder wall is lead away into the cooling medium in the same rate as the heat is created then the compression can principally happen isothermally.

When the gas, after decisions made by an electronic control system, is judged to be enough separated the rotation is being braked in which the contents in the cylinder pour out through the same opening where the gas was initially supplied through, the lightest molecules come out first and the heaviest last. In an armature that surrounds the opening there is a sensor which through the control system measures and detects when for example hydrogen or oxygen or carbon oxide or carbon dioxide starts flowing whereafter a valve in the armature makes the flow in the actual detected gas to go into a conduit to for example a compressor where the gas, considerably cold after the expansion, can be compressed and stored in a tank or in a gas bottle. The lightest gas like hydrogen flows out first and can in the described manner be stored into for example a gas bottle until gas with a heavier molecule is detected and can be led into other storage or into the surroundings.

For maximal product of the separated gas the lapse can be repeated which has to be trialed for in a laboratory manner and different conditions for which the control parameters in the electronic control system should be. “The cylinder is brought up to a constant RPM, molecules are separated, the cylinder's rotation is braked, unwanted gas for example leads into the surroundings and wanted gas leads into for example a compressor with a tank”.

The above-mentioned procedure is characteristically repeated batch-wise which leads to the method being able to be performed with a device that is in comparison to devices built for continuing separation simpler, by size much smaller and with lower costs for manufacture and operating. With batch-wise processing then for example combustion gases can pass through the device without separation of carbon dioxide if the combustion gases aren't also produced batch-wise and in coordination with the method otherwise intended for in the device. But if a separation of carbon dioxide takes place and if the combustion gases originate from biofuel/renewable fuels then so-called negative emissions, that is net emissions with a net result of negative CO2, are made, which are particularly valuable.

The following figure representation compliments the above-mentioned description. An electronic control system with sensors and regulating capabilities are a given these days and can be mentioned when it is appropriate.

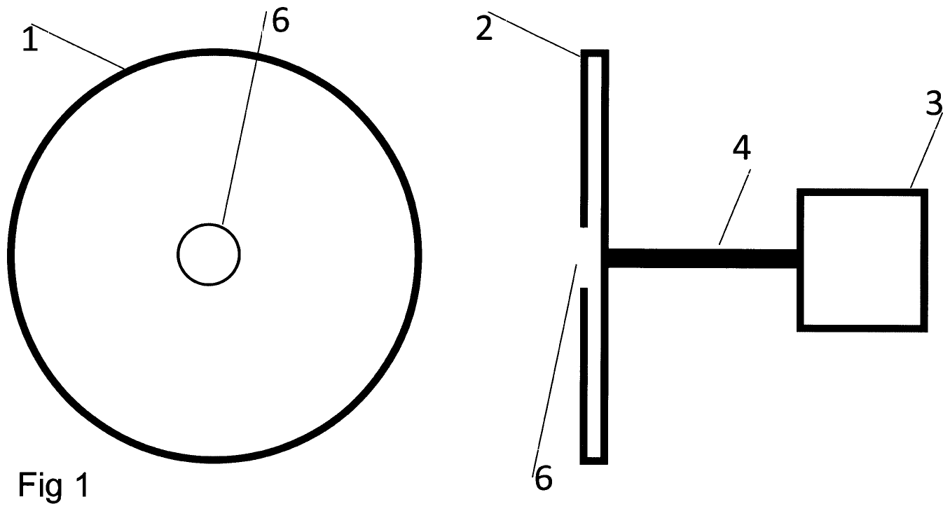

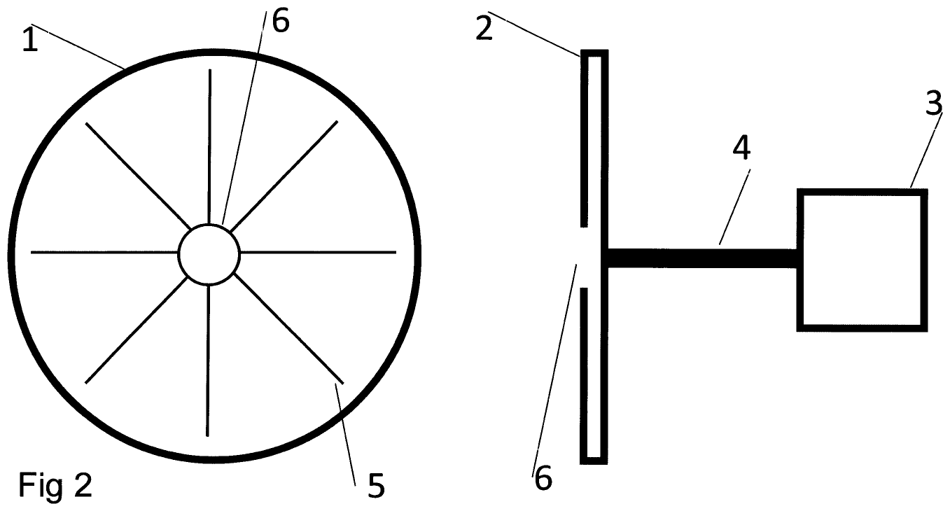

FIG. 1. A cylinder seen from the front 1 and from the side 2 which will be made to rotate with a driving device, for example an electric machine 3, connected to the cylinder through driveshaft 4. In the cylinder there is an impeller not visible from the outside 5 which can be seen in FIG. 2. The impeller is secured to the cylinder which when the cylinder is made to rotate the impeller is simultaneously made to rotate as well. In the middle of the cylinder's front side there is an opening 6, for passage of combustion gas. The relation between the cylinder's diameter, from the front 1, and its length, from the side 2, could be different from what is suggested in this figure. For example the cylinder can be made to be both longer or shorter proportionally speaking.

FIG. 2. A cylinder, which seen from the front 1 and from the side 2, which is brought to rotate with a driving device for example an electric machine, 3 connected to the cylinder through a driveshaft 4. In the cylinder there is an impeller 5 gas tight and firmly secured between the cylinder's front- and back-side. According to the figure the impeller is not connected to the cylinder's peripheral inside which it can be made to do in an alternative configuration. When the cylinder is brought into rotation the actual gas mixture is sucked into the cylinder through an opening 6 for the gas' passage. The supplied gas is brought, through radially acting centrifugal force, under compression to be moved towards the cylinder's peripheral inside and the heaviest molecule for example a carbon dioxide molecule in combustion gas, or oxygen molecules if the gas is made out of air, to be collected just next to the cylinder wall. If there is hydrogen in the supplied gas then it becomes concentrated centrally the furthest away from the cylinder wall. The cylinder is surrounded by a cooling medium, for example surrounding air 12. When the cylinder's rotation is braked the gas existing within the cylinder expands under falling temperature and flows out of the opening 6 whereafter the lightest gas for example hydrogen is flowing out first when centrifuging for example synth gas as the hydrogen is concentrated and collected the closest to the opening. When centrifuging combustion gas the separated carbon dioxide flows out of the opening last as it is otherwise concentrated the furthest away from the opening when being centrifuged and the same applies to oxygen when centrifuging air. With braking some energy can be recycled by making the electric machine start generating electricity as it is braking the rotating device that can be brought back into the electric grid or stored into a battery, this is not shown in the figure.

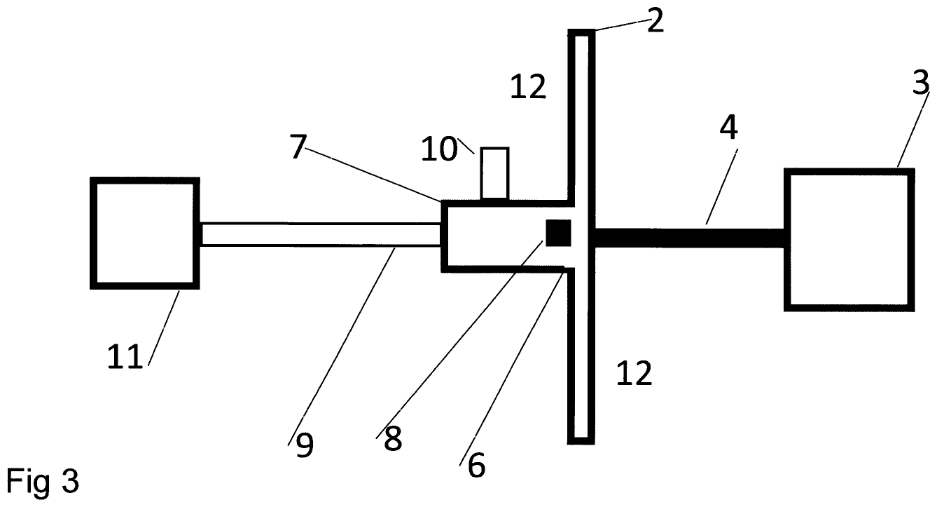

FIG. 3. An armature 7 is gas tightly secured to the opening 6 but without rotating together with the cylinder as the cylinder rotates. The armature involves a sensor 8 for detection of for example hydrogen, oxygen, carbon dioxide or carbon monoxide, as well as an openable and closable duct 9 that leads to a recipient 11, that is made up out of for example a compressor with a tank. Through the duct 10 and the opening 6 there is partially an intake of for example combustion gases, or air, or synth gas, or another gas, when the cylinder RPM is increased and there is partially an outtake of for example combustion gases without carbon dioxide, or air without oxygen, or synth gas without hydrogen, or any other gas/gas mixture without certain particular molecules that have been separated, when the cylinder's rotation is being braked. Alternatively, it could be, not shown in this figure, an intake of a gas mixture that instead of through the typical duct 10 could be made through the drive shaft 4 if the drive shaft is made out of a duct with a check valve to prevent an outflow of gas through the drive shaft when the cylinder's rotation is braked through the electric machine. Via duct 9 there is only an outtake of the gas that is going to be saved and stored for example the previously mentioned carbon dioxide, oxygen or hydrogen or any other gas for example a toxic gas. Sensor 8 as well as the openable and closable duct 9 and 10 are connected to an electronic control system, not shown in figure, and the ducts are controlled and made to open or close by the regulatory devices that are connected to the control system, not shown in figure.

The invention is not only limited to the implementations shown in the figure but modifications can be made within the frame of the following patent claims:

1. A method of batch-wise separation and selection of either heavy and/or light molecules in a gas mixture through a device made up of at least one cylinder (1,2), a cooling medium (12) that surrounds a cylinder, a to the cylinder belonging driving mechanism made up out of for example an electric machine (3) with a drive shaft (4), inside the cylinder a firmly fixed impeller (5), a in the cylinder's center existing opening (6) for passage of gas, a to the opening (6) connected armature (7) involving a sensor (8) for detection of hydrogen, oxygen, carbon monoxide, carbon dioxide or another gas and an openable and closable duct (10) for the supply of a gas mixture that is going to be separated and respectively lead away from the separated gas mixture without a selectively separated gas, one to the armature (7) connected openable and closable duct (9) for selected gas that leads to a recipient (11), whereafter the cylinder is brought into rotation and gas that is meant to be separated is sucked into the cylinder through the opening (6) whereafter the rotation is made to stop and the separated gas flows out of the cylinder through the opening (6), characterized by the fact that it is made batch-wise as the process is being done repeatedly over and over again.

2. The method according to patent claim 1, characterized by the fact that when the cylinder through the driving mechanism is brought into rotation a gas mixture is sucked into the cylinder through opening (6) that through radially acting g-forces is forced to move to the cylinder's periphery.

3. The method according to patent claim 2, characterized by the fact that the cylinder's RPM is increased through a by the control system chosen constant RPM whereafter the heaviest molecules are concentrated along the cylinder's periphery.

4. The method according to patent claim 3, characterized by the fact the cylinder's rotation is occurring under simultaneous cooling.

5. The method according to patent claim 4, characterized by the fact that the cylinder through braking by the driving mechanism has its RPM reduced whereafter an outflow, through the expansion cooled gases, is taking place through the opening (6) to the armature (7) whereafter the outflowing gases are lead to the outtake (10) if not the control system, through signals from the sensor (8) that detect a certain type of gas is ordering the regulating mechanism to close the outflow (10) and to open the duct (9) to a recipient (11).

6. The method according to patent claims 2, 3, 4, 5 characterized by the aforementioned process is repeated as long as for example a car or ship is being driven or say a garbage power plant is being run.

7. According to the execution of the method accordingly to patent claims 1-6, characterized by the fact that it involves a cylinder (1,2), a cooling medium (12) that surrounds the cylinder, a to the cylinder belonging driving device making up out of for example an electric machine (3) with a drive shaft (4), an inside cylinder attached to an impeller (5), a in the cylinder's center existing opening (6) for passage of gas, one to the opening (6) connected armature (7) involving a sensor (8) for detection of hydrogen, oxygen, carbon dioxide, carbon monoxide or another gas and an openable and closable duct (10) for the supply and intake of a gas mixture that is going to be separated and respectively outtake of a separated gas mixture without selected gas, one to the armature (7) connected openable and closable duct (9) for selected gas that are lead to a recipient (11).
